(19) United States
(12) Patent Application Publication
(10) Pub. No.: US 2009/0228973 A1
(43) Pub. Date: Sep. 10, 2009

(54) TECHNIQUES FOR AUTOMATIC DISCOVERY AND UPDATE OF CLIENT ENVIRONMENTAL INFORMATION IN A VIRTUAL PRIVATE NETWORK (VPN)

(76) Inventors: Chendil Kumar, Bangalore (IN); T. Sureshkumar, Tamilnadu (IN)

Correspondence Address: SCHWEGMAN, LUNDBERG & WOESSNER/NOVELL, PO BOX 2938, MINNEAPOLIS, MN, 55402, US

(21) Appl. No.: 12/043,187

(22) Filed: Mar. 6, 2008

(51) Int. Cl. G06F 17/00; G06F 15/16

(52) U.S. Cl. 726/15

(57) ABSTRACT

Techniques for automatic discovery and update of client environmental information in a virtual private network (VPN) are provided. Vendor adapters dynamically monitor information produced by software vendors for change information associated with software products. The change information is transformed into policy rules that are dynamically pushed to client agents on clients. The client agents acquire client information for the policy rules from their clients and report back to a VPN server. The VPN server in cooperation with the client agents then decide whether VPN sessions are permissible between the clients and the VPN server.

### BACKGROUND

Increasingly the affairs of individuals and enterprises are being conducted in an automated manner over the Internet. Enterprises now engage in selling their products and services over the Internet; individuals also engage in communicating with one another over the Internet; employees also engage in accessing secure resources of their employers over the Internet, etc.

One ever present and daunting issue with this activity is Internet security. Some transactions may be innocuous and may not require any substantial security. However, a growing number of transactions do involve sensitive material associated with enterprises and individuals, such as corporate secrets, personal data, etc. A variety of security mechanisms exist to address this issue.

For example, some enterprises may install dedicated connections for secure communications between parties. Yet, this approach is less pervasive with the advent of Virtual Private Network (VPN) techniques. A VPN permits an insecure connection to be used to achieve secure communications between parties engaged in a transaction.

VPN transactions use authentication and encryption techniques for purposes of ensuring that communications are secure. Essentially, a VPN permits insecure communications lines to be used in a secure manner.

In cases where VPN's permit access to enterprise resources, another issue of security arises. That is, clients connecting to the enterprise's secure network via a VPN often have to be checked to ensure they have a compatible and a secure software environment that would permit them to connect to the enterprise's secure network. This means that antivirus software, versions of various software products, etc. have to be checked to ensure the connecting client is compatible and safe for accessing the enterprise's resources.

Yet, antivirus and software patches for an Operating System (OS) and other software products are continually evolving and are usually in a constant state of chaos. This means that administrators are regularly busy updating the permissible versions and patches. The entire process is largely manual and is time consuming. Moreover, the manual process becomes nearly impossible when there is a large software environment to manage across a plurality of client machines.

Consequently, there is a need for improved techniques for automatic discovery and update of client environmental information in a VPN.

### SUMMARY

In various embodiments, techniques for automatic discovery and update of client environmental information in a virtual private network (VPN) are provided. In an embodiment, a method for a vendor agent that facilitates automatic discovery and updating of client environment information engaged in a VPN is presented. A third-party vendor is monitored for information on a software product. The information is parsed from data provided by the third-party vendor for purposes of detecting an update to the software product. Next, a policy rule is constructed for the update and a policy store is updated with the policy rule. The policy rule is subsequently pushed to an agent on a client during initial VPN negotiation for the agent to gather client information relating to the policy rule and for the agent to report that client information back to a VPN connection manager during the VPN negotiation.

### BRIEF DESCRIPTION OF THE DRAWINGS

FIG. 1 is a diagram of a method for a vendor agent that facilitates automatic discovery and updating of client environment information engaged in a virtual private network (VPN), according to an example embodiment.

FIG. 2 is a diagram of a method for a policy enforcer that interacts with the vendor agent of the FIG. 1 and with a client agent to ensure a client has proper environmental information for establishing a VPN session with a VPN server, according to an example embodiment.

FIG. 3 is a diagram of a dynamic VPN client integrity checking (CIC) system, according to an example embodiment.

FIG. 4 is a diagram of another dynamic VPN CIC system, according to an example embodiment.

FIG. 5 is a diagram of an example architecture for the VPN CIC system shown in the FIG. 4, according to a particular embodiment.

### DETAILED DESCRIPTION

A “resource” includes a user, content, a processing device, a node, a service, an application, a system, a software product, a directory, a data store, a World-Wide Web (WWW) site, an end-user, groups of users, combinations of these things, etc. The terms “service,” “module,” “program,” “software product,” and “application” may be used interchangeably herein and refer to a type of software resource that includes instructions, which when executed by a machine performs operations that change the state of the machine and that may produce output. Additionally, a “principal” is a type of resource that actively interacts with other resources. So, a principal may be a user or an automated service.

A “client” is an environment having one or more machines (processing devices, such as but not limited to a computer) that is enabled over a network and that includes resources and in some cases processes the resources. A “server” is also an environment having one or more machines that is enabled over a network and that includes resources and in some cases processes the resources. The terms “client” and “server” when used in combination define a client-server architecture, where the client and server are remote from one another over a network connection, such as a wide-area network (WAN) and insecure public communications network such as the Internet. Both a client and a server may be viewed as types of resources similar to what was described above with reference to the principal.

The term “remote” is used relatively herein. In other words, when the term “remote” is used as an adjective to a noun it is remote or external to some other entity being referenced within the context of the modified noun. So, as an example: a remote application to a service means that the remote application is external to a local environment and local network associated with the service. In other contexts, the service may be viewed as being remote to the application when it is expressed as: a remote service to an application. Within any given context herein, the term remote is used consistently to identify what entity is in fact remote to what other entity.

A “processing environment” refers to one or more physical processing devices organized within a network. For example, several computers connected via a local area network (LAN) may collectively be viewed as a processing environment. The processing environment also refers to software configurations of the physical processing devices, such as but not limited to operating system, file system, directory service, etc.

A “virtual private network (VPN)” is a special type of network that is carved out of or tunneled through another network, such as an insecure network like the Internet. Technically, a VPN does not have to have security features it can be any sub network that tunnels out specific traffic. However, as used herein the VPN uses security features, such as authentication so that secure communications occur via a Secure Sockets Layer (SSL) VPN.

Various embodiments of this invention can be implemented in existing network architectures, storage systems, security systems, data centers, and/or communication devices. For example, in some embodiments, the techniques presented herein are implemented in whole or in part in the Novell® network, proxy server products, email products, operating system products, data center products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

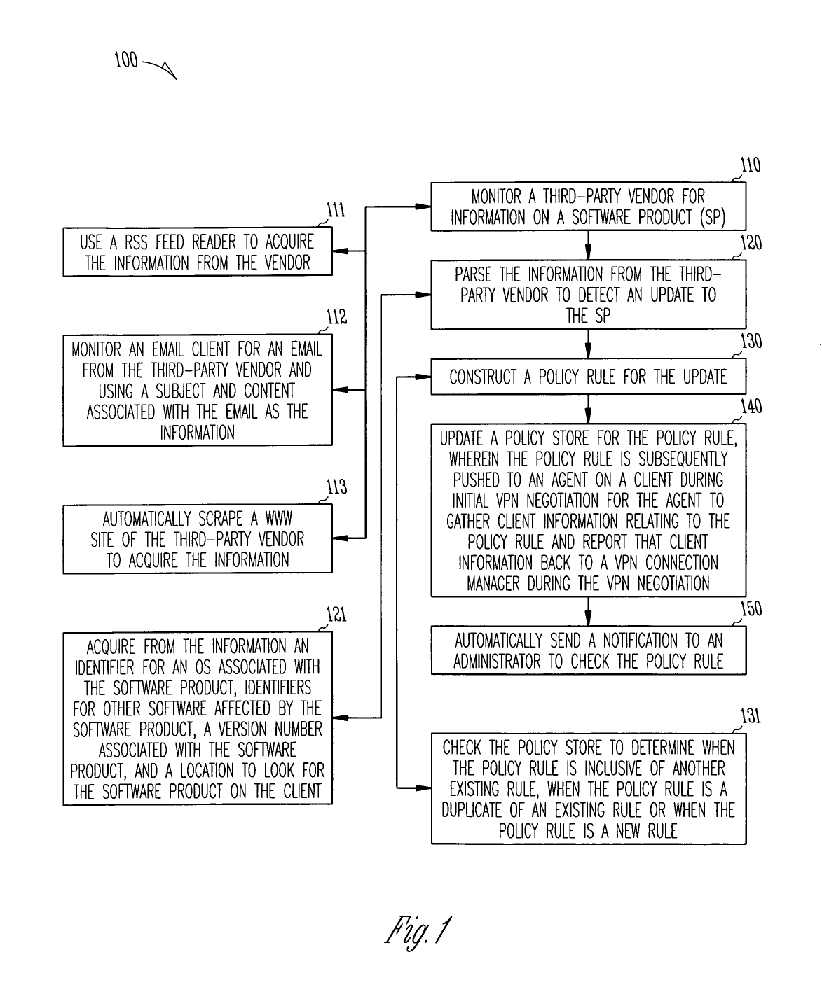

It is within this context, that various embodiments of the invention are now presented with reference to the FIGS. 1-4.

FIG. 1 is a diagram of a method 100 for a vendor agent that facilitates automatic discovery and updating of client environment information engaged in a VPN, according to an example embodiment. The method 100 (hereinafter “vendor plugin”) is implemented as instructions in a machine-accessible and readable medium. The instructions when executed by a machine (computer or processor-enabled device) perform the processing depicted in FIG. 1. The vendor plugin is also operational over and processes within a network. The network may be wired, wireless, or a combination of wired and wireless. In an embodiment, the network is the Internet.

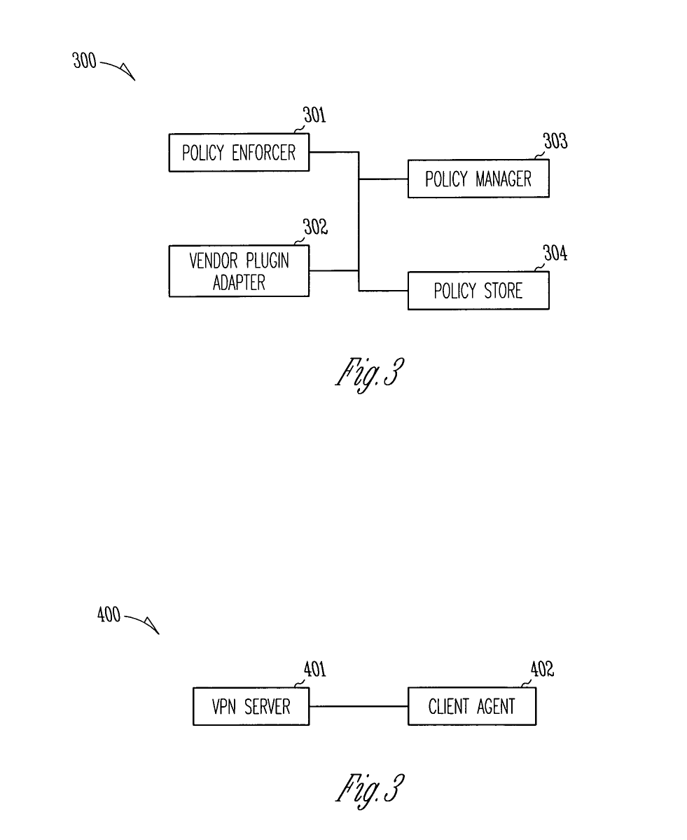

Initially, the vendor plugin is configured for a specific software vendor, such as and by way of example only SUSE® Linux. So, the vendor plugin is designed to monitor and process information or data published or produced by a specific software vendor; the data or information is about one or more software products that the vendor distributes to licensees over the network, such as the Internet. This data or information may include notices about new releases, enhancements, bug fixes, etc. Example architectures within which the vendor plugin operates is provided below with reference to the FIGS. 3-5. It is noted, that a single architecture may include a plurality of vendor plugins, as noted in FIG. 5.

At 110, the vendor plugin monitors a third-party vendor for information or data regarding one or more software products. The monitoring occurs because for purposes of VPN client integrity checking (CIC), the vendor plugin provides (as will be discussed more completely below) an automated mechanism for detecting changes in software products, such as changes in antivirus software, changes in checks for malware, changes in version of an OS, or changes in specific client-installed software.

According to an embodiment, at 111, the vendor plugin uses or enlists the services of a really simple syndication (RSS) feed reader to acquire the information regarding the software product. So, the vendor plugin is subscribed to a designated RSS feed and that feed is published by the software vendor to communicate changes in its software product. OS vendors may provide such a service or vendors can be encouraged as a result of the embodiments taught herein to supply RSS feeds for their software products. Thus, in some cases, software vendors may actively publish, via RSS feeds, information about the latest patches or versions for their software. The vendor plugin subscribes to these feeds and via a RSS reader periodically scans and receives the information.

In another case, at 112, the vendor plugin monitors an email client of an administrator or a user for an email from the third-party software vendor. The vendor plugin parses the incoming emails, such as the subject and sent from fields, to detect when certain emails pertain to the third-party software vendor and software products of the vendor. The contents or body of the email can then be parsed to acquire the information that the software vendor is communicating about the software product via the email. In this manner, emails can be monitored and automatically parsed for update information about software products.

In yet another situation, at 113, the vendor plugin periodically (at configurable intervals) scrapes a designated world-wide web (WWW) site or page associated with the third-party software vendor for purposes of acquiring the information. The site or page can be configured with the vendor plugin, such that the vendor plugin can periodically visit the site or page and scrape the site or page for the information about the vendor's software products.

It is noted, that the vendor plugin is initially configured for a specific software vendor or set of similar vendors. The configuration details instruct the vendor plugin on where to acquire the information and how to parse it out, via one or more rules or grammars that may be specific to the information produced by the software vendor.

Accordingly, at 120, the vendor plugin parses the information acquired at 110 to detect meaningful update information for the software product being monitored.

For example, at 121, the vendor plugin acquires a variety of information as a result of the parsing, such as an identifier for an OS associated with the software product, identifiers for other software affected by changes in the software product being monitored, a version number for the software product, and even a location (such as directory path) to look for the software product on a client machine.

The parsed information represents an update that was detected for the software product.

At 130, the vendor plugin constructs a new policy rule for the update. The new policy represents instructions that can be evaluated, such as check for version N of product X at location Y on client machine Z and return a success or failure indication in response to the check. This is but one example as the policy rule may be more complex and involve an identity for a particular user or may permit several different versions to be present for a success indication to be returned.

According to an embodiment, at 131, the vendor plugin checks a policy store to determine when the policy rule is inclusive or part of an existing rule or to determine when the policy rule is a duplicate of the existing rule. This provides a mechanism to ensure that only a portion of an existing policy rule changes in response to the new policy rule generated and provides a mechanism to ensure that the new policy rule is not added when it is in fact a duplicate.

Next, at 140, the vendor plugin updates the policy store for the new policy rule (assuming that the new policy rule was not a duplicate, as discussed above at 131). The policy rule is now in a condition for automated use for CIC during initial VPN negotiation. That is, the policy rule is subsequently dynamically and in real time pushed to an agent on a client during initial VPN negotiation. The client agent uses this policy rule to gather client information (detailed in the policy rule) and report back to a VPN server or VPN connection manager during VPN negotiation. The report back may be a success or failure indication as discussed above at 130.

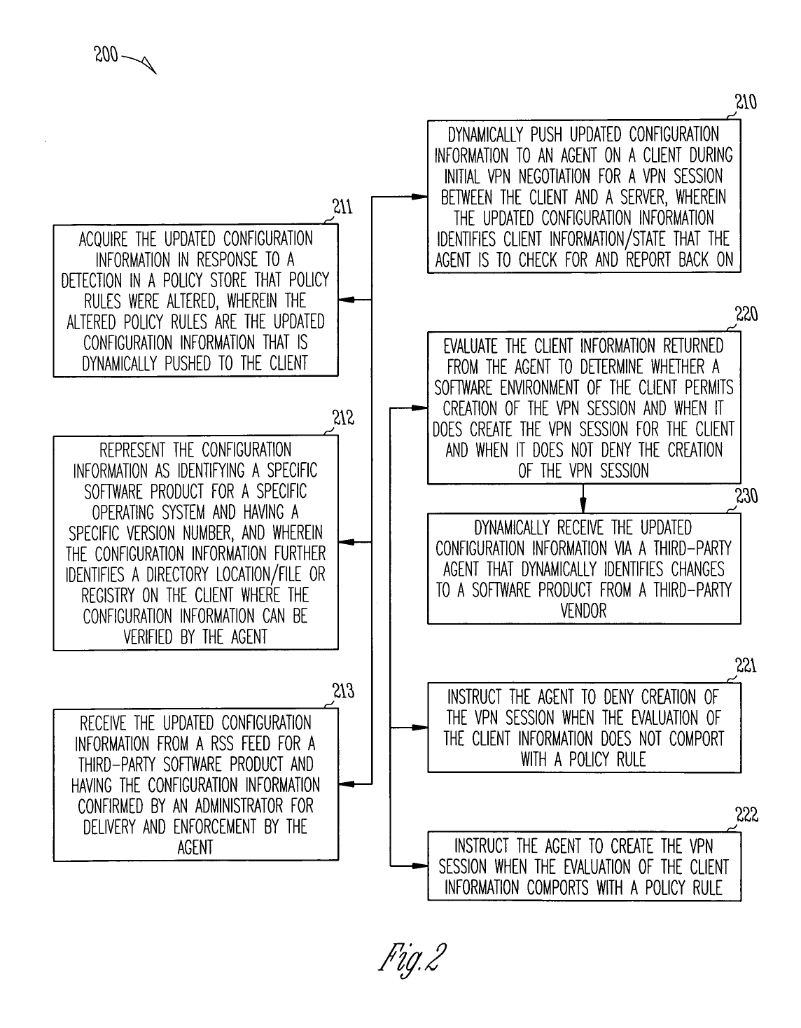

At this point as is discussed in greater detail below with reference to the FIGS. 2-5, a decision can be made as to whether a VPN session between the client and the VPN server is to be permitted or denied based on the CIC that occurred with evaluation of the policy rule. There are also some variations on the processing discussed above that can be done; these variations are also discussed in greater detail below.

In an embodiment, at 150, the vendor plugin also automatically sends a notification to an administrator to manually check the newly formed policy rule. This is done to provide a manual override and to provide some manual oversight of the automated process because there may be situations where the administrator may not want the policy to take effect. For example, an enterprise as a whole may have made a decision not to move to an upgraded version of a particular piece of software because the enterprise may not view it as being stable or may have some other legacy software compatibility issues to work out before the migration occurs. So, there may be situations where the enterprise wants the ability to override automated actions of the vendor plugin. The notification process permits a mechanism for manual oversight and manual override to occur. More detailed examples of this are also provided below with reference to the FIGS. 2-5.

FIG. 2 is a diagram of a method 200 for a policy enforcer that interacts with the vendor agent of the FIG. 1 and with a client agent to ensure a client has proper environmental information for establishing a VPN session with a VPN server, according to an example embodiment. The method 200 (hereinafter “policy enforcer”) is implemented in a machine-accessible and readable medium as instructions. The instructions when executed by a machine perform the processing depicted in the FIG. 2. Moreover, the policy enforcer is operational over a network, and the network may be wired, wireless, or a combination of wired and wireless.

The policy enforcer interacts with one or more instances of the vendor plugin represented by the method 100 of the FIG. 1 and also interacts with a client agent. The interactions and processing associated with the policy enforcer is described in detail below. Moreover, example architectures within which the policy enforcer operates is presented in detail below with reference to the FIGS. 3-5.

At 210, the policy enforcer dynamically and in real time pushes updated configuration information to an agent on a client during initial VPN negotiation that is occurring between the client and a server for purposes of attempting to establish a VPN session between the client and the server. The updated configuration information identifies client information that the agent is to check for and report back on during the VPN negotiation. This may be in addition to any other VPN authentication that occurs during VPN negotiations between the client and the server. In an embodiment, the configuration information is the policy rule that was produced by the vendor plugin discussed above with reference to the method 100 of the FIG. 1.

According to an embodiment, at 211, the policy enforcer acquires the updated configuration information in response to a detection in a policy store that policy rules were altered in some manner, such as via automated update by the vendor plugin. So, the altered policy rules may be viewed as the updated configuration information that is then dynamically and in real time pushed to the agent on the client over the network (such as but not limited to the Internet).

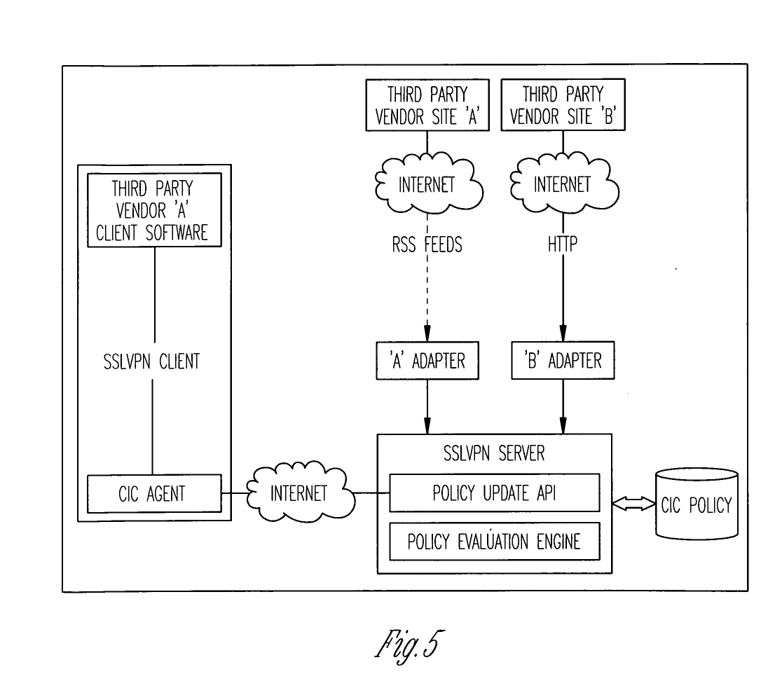

In an embodiment, at 212, the policy enforcer detects that the configuration information is represented as information that identifies a specific software product for a specific operating system having a specific version or patch number. The configuration information may also further identify a specific directory/file location or Registry on the client there the configuration information can be verified by the client agent. Below, the FIG. 3 shows how a CIC Policy is framed and in the FIG. 4 an explanation of the interaction between a VPN server and the VPN client for tunnel establishment is explained.

In some cases, at 213, the policy enforcer receives the updated configuration information from a RSS feed for a third-party software product. Other policy rules may also require that the configuration information be confirmed by an administrator before delivery and enforcement of the configuration information takes place at the client by the client agent. Again, this is an opportunity for manual oversight and manual override so as to prevent some updates to software products from being immediately enforced by the policy enforcer.

At 220, the policy enforcer evaluates the client information returned from the client agent to determine whether a software environment of the client permits creation of the VPN session between the client and the server. The returned information may be a success indication or a failure indication or it may be specific metrics acquired by the client agent, such as date a new version was installed on the client, libraries used during the install, etc. If the evaluation is successful then the VPN session is established; otherwise the VPN session is not established and it is denied. This is a dynamic CIC performed in an automated manner that does not require any prior administrator configuration or intervention to take place. Conventionally, the CIC process was exclusively manual and labor intensive.

In an embodiment, at 221, the policy enforcer instructs the agent to deny creation of the VPN session when the evaluation of the client information does not comport with another policy rule.

Similarly, at 222, the policy enforcer instructs the agent to create and proceed with the VPN session when the evaluation of the client information comports with the policy rule.

According to an embodiment, at 230, the policy enforcer dynamically and in real time receives the updated configuration information via a third-party agent, such as the vendor plugin discussed above with reference to the method 100 of the FIG. 1. The third-party agent dynamically and in real time identifies changes to a specific software product for a specific third-party software vendor or distributor. It is noted that the policy enforcer may interact or enlist the services of a variety or different third-party agents, each agent associated with a particular software vendor, distributor, and/or product.

FIG. 3 is a diagram of a dynamic VPN client integrity checking (CIC) system 300, according to an example embodiment. The VPN CIC system 300 is implemented in a machine-accessible and computer-readable medium as instructions. The instructions when executed by a machine perform, among other things, the processing depicted in the methods 100 and 200 of the FIGS. 1 and 2, respectively. Moreover, the VPN mode switching system 300 is operational over a network, and the network may be wired, wireless, or a combination of wired and wireless.

The VPN CIC system 300 includes a policy enforcer 301 and a vendor plugin 302. In an embodiment, the VPN CIC system 300 also includes a policy manager 303 and/or a policy store 304. Each of these will now be discussed in turn.

The policy enforcer 301 is implemented in a machine-accessible and computer-readable medium as instructions that execute on a server machine of a network. Example processing associated with the policy enforcer 301 was discussed in detail above with reference to the method 200 of the FIG. 2.

The vendor plugin 302 is implemented in a machine-accessible and computer-readable medium as instructions that execute on the server machine or another machine of the network. Example processing associated with the vendor plugin 302 was discussed in detail above with reference to the method 100 of the FIG. 1.

As used herein the vendor plugin 302 may be referred to synonymously with the phrase “vendor plugin adapter 302.”

The vendor plugin 302 dynamically and in real time monitors a vendor for changes that occur to a software product that the vendor distributes. When the vendor plugin 302 detects a change, the vendor plugin 302 gathers change information for the software product and produces a policy rule that is then dynamically communicated in real time to the policy enforcer 301.

The policy enforcer 301 then dynamically and in real time pushes the policy rule to a client agent of the client during a VPN negotiation between the client and a server. The client agent gathers information for the software product on the client in accordance with the policy rule and returns the client information back to the policy enforcer 301. The policy enforcer 301 then instructs the client agent on whether it is permissible or not permissible for a VPN session to be established between the client and the server.

In an embodiment, the VPN CIC system 300 also includes a policy manager 303 implemented in a machine-accessible and computer-readable medium and processes on the server machine.

The policy manager 303 presents and provides an administrative interface to an administrator to create, view, modify, and/or delete the policy rule or other policy rules that are enforced by the policy enforcer 301. This was discussed above with reference to the methods 100 and 200 of the FIGS. 1 and 2, respectively. The policy manager 303 provides a mechanism for manual administrator oversight and override.

In another embodiment, the VPN CIC system 300 includes a policy store 304. The policy store 304 is implemented in a machine-accessible and computer-readable medium and is accessible to both the policy enforcer 301 and the vendor 301.

The policy store 304 houses the policy rule and other policy rules that are either manually created by an administrator via the policy manager 303 or that are automatically updated via the vendor plugin adapter 302. The policy enforcer 301 also receives notices of policy rule additions or changes and acquires them from the policy store 304.

In an embodiment, the policy rule formed by the vendor plugin adapter 302 is initially received in the policy store 304 with a passive or inactive state attribute. This ensures that it is not dynamically pushed to the client agent via the policy enforcer 301 until an administrator, via the policy manager 303, activates the policy rule or authorizes its usage. Once authorized, the policy rule is immediately and automatically communicated from the policy store 304 to the policy enforcer 301, where it is then pushed to the client agent for CIC enforcement during VPN negotiations.

According to an embodiment, the administrator uses the interfaces of the policy manager 301 to also initially configure the vendor plugin adapter 302 for monitoring information produced by the vendor of the software product. So, the policy manager 301 can be used to configure the vendor plugins 302 in addition to creating, modifying, deleting, and/or activating policy rules.

FIG. 4 is a diagram of another dynamic VPN CIC system 400, according to an example embodiment. The VPN CIC system 400 is implemented as instructions on or within a machine-accessible and readable medium. The instructions when executed by one or more machines perform, among other things, processing depicted with respect to the methods 100, 200 of the FIGS. 1-2, respectively, and the system 300 of the FIG. 3. The VPN CIC system 400 is also operational over a network, and the network may be wired, wireless, or a combination of wired and wireless.

In an embodiment, the VPN CIC system 400 presents another and in some cases enhanced perspective of the VPN CIC system 300 represented by the FIG. 3 above.

The VPN CIC system 400 includes a VPN server 401 and a client agent 402. Each of these and their interactions with one another will now be discussed in turn.

The VPN server 401 is implemented in a machine-accessible and computer-readable medium as instructions that process on a server machine (computer or processor-enabled device) of a network. Example processing associated with the VPN server 401 was presented in detail above with reference to the methods 100 and 200 of the FIGS. 1 and 2, respectively, and with respect to the system 300 of the FIG. 3.

The VPN server 401 interacts with one or more vendor adapters. Each vendor adapter dynamically, automatically, and in real time monitors a particular software vendor for information on changes to software products distributed by that particular software vendor. In other words, and in some cases, each vendor adapter is vendor or software product specific. Each vendor adapter also produces new or updated policy rules that are communicated to the VPN server 401.

The VPN server 401 pushes (automatically, dynamically, and in real time) new or updated policy rules to the client agent 402 during VPN negotiation between the client machine and the server machine.

The client agent 402 is implemented in a machine-accessible and computer-readable medium and is to process on a client machine of the network. Some actions associated with the client agent 402 were discussed above with reference to the methods 100 and 200 of the FIGS. 1 and 2, respectively, and with respect to the system 300 of the FIG. 3.

The client agent 402 supplies the client information regarding the policy rule instructions back to the VPN server 401. The VPN server 401 then instructs the client agent 402 to permit or deny the creation of a VPN session between the client machine and the server machine in response to evaluation of the client information returned from the client agent 402 back to the VPN server 401.

In an embodiment, the client agent 402 during the VPN negotiation scans the client machine for antivirus software, OS patches, patches for installed programs that are on the client machine, and/or for the presence of malware on the client machine. This is done in response to the new or update policy rules delivered by the VPN server 401.

According to an embodiment, the client agent 402 is preinstalled and pre-exists on the client machine before the VPN negotiation takes place.

In an alternative embodiment, the client agent 402 is dynamically and in real time delivered and installed on the client machine by the VPN server 401 during the initial VPN negotiation. In some cases, the dynamic delivery of the client agent 402 occurs each time a new VPN session is attempted by a client machine. In other cases, the dynamically delivery occurs for a first attempt by the client machine for a first VPN session and subsequent to that the client agent 402 is detected as being preinstalled and pre-existing on the client machine, such that subsequent delivery of the client agent 402 is unnecessary.

In a particular case, at least one vendor adapter is configured to evaluate RSS feeds for one of the software vendors while another one of the vendor adapters is configured to scrape a WWW site or page for another vendor and while yet another one of the vendor adapters is configured to parse an email received from still another vendor. This is done for purposes of acquiring the information on the changes to the software products.

FIG. 5 is a diagram of an example architecture for a VPN CIC system, according to a particular embodiment. FIG. 5 is presented for purposes of illustration and comprehension and is not intended to limit various embodiments of the invention presented herein.

A variety of components are discussed in the FIG. 5, each of these components and their interactions with one another are now discussed with reference to the FIG. 5.

The sample illustration of the FIG. 5 shows a SSL VPN architecture. It is noted that other VPN architectures may be used as well without departing from the beneficial teachings presented herein.

The SSL VPN Architecture contains a SSL VPN gateway server which manages VPN connections from clients. Upon initiation of a VPN connection from a client, a process called Client Integrity Check (CIC) is initiated at the client. This process is carried out by an agent at the workstation (client agent). This agent scans the workstation for known antivirus software, OS patches, patches for known programs already installed, any malware present on the workstation, etc. It is noted that the agent can be preinstalled on the client or the agent can be a dynamically down loadable software through ActiveX or Java technology. The agent collects the details required for CIC evaluation and sends the details back to the SSL VPN server. The SSLVPN server also includes a CIC policy evaluation engine. The CIC policy evaluation engine receives the information from the client agent and evaluates that information. If this evaluation is successful, then the SSL VPN server proceeds with the VPN negotiation for establishing a VPN session between the client and the server. If the evaluation is unsuccessful, the SSL VPN server can take any required necessary action, such as denying the VPN connection.

It is important for the CIC engine at the server to be up-to-date with the latest security policies of an enterprise. An Administrator typically takes the responsibility of updating the policies whenever required with conventional approaches. So, conventionally, an Administrator usually updates the policies whenever a patch is available for any client software, OS or whenever a new virus definition file is released by an antivirus vendor. Conventionally, the administrator uses an application user interface (UI) to manually update these CIC policies. This process is very important to corporate network security. This puts a tremendous burden on IT administrators and is extremely time consuming and laborious.

The techniques presented and described herein and above introduce an intelligent and automated mechanism by which CIC processing can be automated. By implementing the solution presented herein, administrators can easily manage the servers without worrying about network security being compromised. The mechanism introduces a component called “CIC policy Updater.” This component exposes an interface through which the CIC policies can be updated. The mechanism also benefits when software vendors publish the information about latest patches and software versions in publicly available RSS feeds.

The information acquired in those feeds may minimally contain Operating System, Affected Software, and Patch Version.

Having this information available, the mechanism proposes to write an adapter, which reads these feeds periodically and parses the information. These adapters find the latest updates published in those feeds. The adapters then update the CIC policies via an interface. A typical update includes information about what to check and where to check for the new version of the patch in the workstation.

The interface to update the CIC policies is generic. Also, the SSL VPN server provides plugin adapters for most of the vendors. Moreover, since the CIC update interface is generic, an administrator can write their own adapters which parses the feeds and update the CIC policies.

Some vendors may not provide such security update information in RSS feeds. That is, some of these vendors provide security bulletins through emails. Hence, an adapter is written which can read the emails and update the CIC policies. This also improves coverage because administrators can update policies by sending emails.

Some vendors may not provide either RSS feeds or security bulletin emails. However, they may publish their security news and update news in their public website. An adapter can be written, which can read the Hypertext Transfer Protocol (HTTP) news and can parse the news into a RSS feed format. Then this adapter can update the CIC policies.

Here are some example use cases that utilize the techniques presented herein to keep CIC policies up-to-date.

Policy Discovery Mechanism:
1. Administrator installs the Access Manager VPN solution.
2. Administrator configures the necessary parameters in a UI Console.
3. In CIC policy configuration: an UI is provided, which lists the Vendor's Name for which plugins are available.
4. Administrator selects the vendor in a Combo Box:
   i. A text box which shows the URL link to RSS feed/HTML page. This filled with default value to the vendor site. Administrator can change this URI
   ii. Administrator clicks the “Discover” Button.
   iii. This triggers a process which navigates the selected URI feed.

It parses the feed for known CIC parameters. It forms necessary rules and displays the rules to the Administrator. Administrator scans these generated rules and enables each one by one.

Policy Update Mechanism:
This is triggered by the adapter plugin.
Adapter plugin identifies an update in the RSS feeds based on publication date.
Adapter plugin parses the feed for new set of:
   patch release
   version release
   malware threat information
Adapter plugin forms a new CIC policy.
Adapter plugin evaluates whether this policy is inclusive in another already existing policy.
Adapter plugin writes this policy into policy store in passive state.
This policy may be passive for configured period of time, after which the policy goes live.
Adapter plugin triggers a mail or alert to the Administrator with the presence of new CIC policy along with an URL to the administration console.
Upon receiving the note, administrator clicks the link.
Administrator verifies that the policy is legitimate and enables the policy.
An option is given which removes the passivity time for new CIC policies. This speeds up the process of making the new CIC policy live for clients.

Components:

The following are the participating components in the example architecture presented with the FIG. 5.
CIC Policy Agent
CIC Policy enforcer
CIC Policy Manager
CIC Vendor Plugin Adapter

CIC Policy Manager:

This component is responsible for managing Client Integrity Policies. This component is implemented as a VPN Server Side component. This Component provide a UI for creating, viewing, modifying, and/or deleting Client Integrity Policies.

Another role for this component is to provide a programmable interface for managing the CIC policies. The programmable interface can either be a direct binary interface like COM Dispatch or RPC like interface (CORBA, .NET remoting, etc.). This provides a way for participating components, internal or external, to publish new CIC policies from multiple locations.

CIC Policy Enforcer:

This component is responsible for enforcing the CIC policies. This component also runs in the VPN server. A client running on the client machine collects necessary details from the client system and sends the information. This component runs on the server over a secure connection. This component also decides and sends what information is to be collected on the client machine. This component then evaluates against the configured CIC policies and sends the result to the CIC Agent.

CIC Agent:

This component runs on the client. This is responsible for collecting necessary information on the client machine as directed by CIC Policy enforcer. This component also runs on the system all the time. This is used to collect the information and if any changes are found in the system, it initiates a new CIC policy evaluation. If that fails, this agent is responsible for denying the VPN connection.

CIC Vendor Adapter Plugin:

The major responsibilities of this components are
watching the feeds, websites and mails of a configured vendor.
parsing the information posted on these feeds for potential new CIC policies.
constructing the CIC policy rules from these parsed structure
Identifying and removing duplicate and inclusive rules in the CIC Policy Store with this particular vendor. Updating the CIC Policy store with new identified policies via CIC Policy Manager.
Alerting administrator about new policies.

This component interacts with CIC Policy manager on the published APIs. This component periodically polls the configured feeds for new publications. Vendors updates their feeds whenever they release a new patch or software update. This component picks it up and constructs a new CIC Policy. This component also figures out whether this rule is an inclusive rule of existing one or whether this is a duplicate. Then, this component updates the Policy Manager about the new role. This component then also triggers a mail or alert event to Administrators.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
monitoring a third-party vendor for information on a software product;
parsing the information from the third-party vendor to detect an update to the software product;
constructing a policy rule for the update; and
updating a policy store for the policy rule, wherein the policy rule is subsequently pushed to an agent on a client during initial virtual private network (VPN) negotiation for the agent to gather client information relating to the policy rule and report that client information back to a VPN connection manager during the VPN negotiation.

2. The method of claim 1, wherein monitoring further includes using a really simple syndication (RSS) feed reader to acquire the information from the vendor.

3. The method of claim 1, wherein monitoring further includes monitoring an email client for an email from the third-party vendor and using a subject and content associated with the email as the information.

4. The method of claim 1, wherein monitoring further includes automatically scraping a world-wide web (WWW) site of the third-party vendor to acquire the information.

5. The method of claim 1, wherein parsing further includes, acquiring from the information an identifier for an operating system (OS) associated with the software product, identifiers for other software affected by the software product, a version number associated with the software product, and a location to look for the software product on the client.

6. The method of claim 1, wherein constructing further includes checking the policy store to determine when the policy rule is inclusive of another existing rule, when the policy rule is a duplicate of an existing rule or when the policy rule is a new rule.

7. The method of claim 1 further comprising, automatically sending a notification to an administrator to check the policy rule.

8. A machine-implemented method, comprising:
dynamically pushing updated configuration information to an agent on a client during initial virtual private network (VPN) negotiation for a VPN session between the client and a server, wherein the updated configuration information identifies client information that the agent is to check for and report back on during the VPN negotiation between the client and the server; and
evaluating the client information returned from the agent to determine whether a software environment of the client permits creation of the VPN session and when it does creating the VPN session for the client and when it does not denying the creation of the VPN session.

9. The method of claim 8 further comprising, dynamically receiving the updated configuration information via a third-party agent that dynamically identifies changes to a software product from a third-party vendor.

10. The method of claim 8, wherein dynamically pushing further includes receiving the updated configuration information from a really simple syndication (RSS) feed for a third-party software product and having the updated configuration information confirmed by an administrator for delivery and enforcement by the agent.

11. The method of claim 8, wherein dynamically pushing further includes acquiring the updated configuration information in response to a detection in a policy store that policy rules were altered, wherein the altered policy rules are the updated configuration information that is dynamically pushed to the client.

12. The method of claim 8, wherein dynamically pushing further includes representing the configuration information as identifying a specific software product for a specific operating system and having a specific version number, and wherein the configuration information further identifies a directory location on the client where the configuration information can be verified by the agent.

13. The method of claim 8, wherein evaluating further includes instructing the agent to deny creation of the VPN session when the evaluation of the client information does not comport with a policy rule.

14. The method of claim 8, wherein evaluating further includes instructing the agent to create the VPN session when the evaluation of the client information comports with a policy rule.

15. A machine-implemented system, comprising:
a policy enforcer implemented in a machine-accessible and computer-readable medium on a server machine of a network; and
a vendor plugin adapter implemented in a machine-accessible and computer-readable medium on the server machine or another machine of the network;
wherein the vendor plugin adapter dynamically and in real time monitors a vendor for changes to a software product distributed by the vendor, and wherein when a change is detected, the vendor plugin adapter gathers change information for the software product and produces a policy rule that is communicated to the policy enforcer, the policy enforcer then dynamically and in real time pushes the policy rule to a client agent during a virtual private network (VPN) negotiation between the a client and a server, the client agent gathers information for the software product on the client in accordance with the policy rule and returns it to the policy enforcer, the policy enforcer then instructs the client agent whether it is permissible or not permissible for a VPN session to be established between the client and the server.

16. The system of claim 15 further comprising, a policy manager implemented in a machine-accessible and computer-readable medium and to process on the server machine, wherein the policy manager provides an administrative interface for an administrator to create, view, modify, and delete the policy rule or other policy rules that are enforced by the policy enforcer.

17. The system of claim 16 further comprising, a policy store implemented in a machine-accessible and computer-readable medium and accessible to the policy enforcer and the vendor plugin adapter, and wherein the vendor plugin adapter is to store the policy rule in the policy store where it is communicated and acquired by the policy enforcer.

18. The system of claim 17, wherein the vendor plugin adapter determines when storing the policy rule in the policy store whether the policy rule is included within an existing policy rule as a portion of that existing policy rule or whether the policy rule is an entirely new policy rule.

19. The system of claim 17, wherein the policy rule is initially inactive or in a passive state within the policy store until the administrator, via the policy manager, activates the policy rule at which time it is immediately communicated from the policy store to the policy enforcer.

20. The system of claim 17, wherein the policy manager is used by the administrator to initially configure the vendor plugin adapter for monitoring information produced by the vendor for the software product.

21. A machine-implemented system, comprising:
a virtual private network (VPN) server implemented in a machine-accessible and computer-readable medium and to process on a server machine of a network; and
a client agent implemented in a machine-accessible and computer-readable medium and to process on a client machine of the network;
wherein the VPN server interacts with one or more vendor adapters, each vendor adapter dynamically and in real time monitors a particular software vendor for information on changes to software products distributed by that particular software vendor, each vendor adapter also produces new or updated policy rules that are communicated to the VPN sever, the VPN server pushes the new or updated policy rules to the client agent, the client agent gathers client information that comports with the new or updated policy rules during VPN negotiation between the client machine and the server machine and supplies the client information back to the VPN server, the VPN server then instructs the client agent to permit or deny the creation of a VPN session between the client machine and the server machine in response to evaluation of the client information.

22. The system of claim 21, wherein the client agent during the VPN negotiation scans the client machine for antivirus software, operating system patches, patches for installed programs on the client machine, and for the presence of malware on the client machine in response to the new or updated policy rules delivered by the VPN server during the VPN negotiation.

23. The system of claim 21, wherein the client agent is preinstalled on the client machine before the VPN negotiation takes place.

24. The system of claim 21, wherein the VPN server dynamically delivers and installs the client agent on the client machine during initial configuration of the VPN negotiation.

25. The system of claim 21, wherein at least one vendor adapter is configured to evaluate really simple syndication (RSS) feeds from one of the software vendors, and wherein another of the vendor adapters is configured to scrape a world-wide web (WWW) site for another one of the software vendors, and wherein still another of the vendor adapters is configured to parse an email received from yet another one of the software vendors for purposes of acquiring the information on the changes to the software products.
